(19) United States
(12) Patent Application Publication
(10) Pub. No.: US 2014/0279511 A1
(43) Pub. Date: Sep. 18, 2014

(54) Systems and Methods for Management of Local Devices

(71) Applicant: MONEYGRAM INTERNATIONAL, INC., Minneapolis, MN (US)

(72) Inventors: Billy Joe Steiger, Ovilla, TX (US); Michael E. Hermansen, Shorewood, MN (US); Joel Kosloski, Grand Prairie, TX (US); Jacob Walter Wagner, Carver, MN (US)

(73) Assignee: Moneygram International, Inc., Minneapolis, MN (US)

(21) Appl. No.: 13/829,768

(22) Filed: Mar. 14, 2013

(51) Int. Cl. G06Q 20/40

(52) U.S. Cl. CPC G06Q 20/40
USPC 705/44; 705/39

(57) ABSTRACT

Systems, methods and devices which provide controls to a parent entity over computing resources residing with an agent entity are discussed herein. In one example, embodiments may allow a parent entity to control peripheral hardware devices which are otherwise controlled locally by a computing device at an agent location. Further, in one embodiment, a parent entity may control the receipt of information from an agent computing device in order to authenticate the agent device. In one embodiment, such control may be implemented via a shell application that executes on an agent computing device when the agent is processing a financial transaction via a web browser interface.

### TECHNICAL FIELD

The present application relates to managing local computing resources and peripherals, and more specifically to providing remote management to a computing device having local control of such resources.

### BACKGROUND

Generally speaking, money transfers are real-time transactions in that a transaction begins when a sender initiates the transaction at the time the money is to be sent to a receiving party. For example, a money transfer may be utilized in an emergency setting when a receiving party has an immediate need for funds. In such a transaction, a sender initiates a money transfer transaction with a money transfer service, such as with a local agent located within a MoneyGram® location. When the transaction information is gathered and the structure of the transaction is finalized, the sender provides the funds to a money transfer agent at or before the time that the funds of the transaction are actually transferred.

Once the funds are received at the time of the transaction, the agent may then provide a transaction code or some other form of transaction identifier to the sender. The sender will then provide the transaction code or identifier to the receiver. With this code the receiver may enter an agent location and complete the transaction and receive the transferred funds.

When facilitating a money transfer transaction there are numerous considerations that must be accounted for by the money transfer service. For example, various regulatory rules may be placed on the manner in which a transaction is conducted. Often times compliance with different regulations is mandated in multiple jurisdictions where a money transfer is taking place. Because of this, money transfer services have various internal rules and procedures in place to insure that transactions are executed in the best manner.

Implementing internal rules and procedures may present its own difficulties. For example, many times money transfer service companies utilize a principal/agent relationship where there is a central or parent entity and a plurality of agents that may be associated with different companies and are configured to conduct transactions between each other via the central entity. Because of this, there are potentially hundreds of different parties that are all attempting to implement the procedures, comply with their different local jurisdictional requirements, and the like. Further, the central entity may be effected by compliance/non-compliance with these procedures by an agent entity which may result in inefficiencies, cause financial harm, or may otherwise damage the goodwill of the parent company.

### BRIEF SUMMARY

The present application provides for systems, methods and devices which provide controls to a parent entity over computing resources residing with an agent entity. In one example, embodiments may allow a parent entity to control peripheral hardware devices which are otherwise controlled locally by a computing device at an agent location. Further, in one embodiment, a parent entity may control the receipt of information from an agent computing device in order to authenticate the agent device. In one embodiment, such control may be implemented via a shell application that executes on an agent computing device when the agent is processing a financial transaction via a web browser interface.

In accordance with one embodiment a method may be provided which provides a web-based interface that allows an agent to provide details regarding a financial transaction from an agent computing device. The method also includes providing a shell application to the agent computing device, where the shell application is configured to access resources of the agent computing device. Additionally, the method may also utilize the web-based interface and resources accessed by the shell application to generate the financial transaction.

In accordance with another embodiment a computer program product having a non-transitory computer readable medium with code encoded thereon is provided. When the code is executed, the computer program product causes one or more processing devices to administer a web-based interface which allows an agent to provide details regarding a financial transaction from an agent computing device. Additionally, the processing devices administer a shell application to the agent computing device wherein the shell application is configured to access resources of the agent computing device, and utilize the web-based interface and resources accessed by the shell application to generate the financial transaction.

Another embodiment may be characterized as a method for administering a device in a financial transaction network. The method includes receiving transaction data at a central server where the transaction data is entered at an agent device via a web interface. The method also includes authenticating the agent device by receiving data provided via a shell application residing on the agent device. Further, upon authenticating the agent device, the method includes providing access, by the central server, to one or more resources on the agent device via the shell application.

In yet another embodiment an apparatus for implementing financial transactions is provided. The apparatus comprises an agent computer having at least one processor and memory coupled to the processor. The processor is configured to execute a web-based transaction application which allows a user to input transaction details in order to initiate a financial transaction. Additionally, the processor is configured to execute a shell application which provides a pre-determined level of access to resources of the agent computer, where the level access provided by the shell application is controlled by a central server.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a money transfer network in accordance with an embodiment of the present application;

FIG. 2 illustrates a functional block diagram illustrating devices in a money transfer network system in accordance with an embodiment of the present application;

FIG. 3 illustrates a method for performing a financial transaction in accordance with an embodiment of the present application; and

FIG. 4 illustrates a method for performing a financial transaction in accordance with an embodiment of the present application.

### DETAILED DESCRIPTION

FIG. 1 illustrates a financial transaction computing network 100 in accordance with an embodiment of the present application. Financial transaction computing network 100 may include one or more central servers 110. Central servers 110 correspond to a central or parent entity which administers money transfer transactions between agent devices 120. Central servers 110 may be commonly located or distributed geographically. Additionally, the administration of a money transfer transaction and/or the configuration of one or more agent devices 120 may be implemented by a single server, or by using multiple processing resources of a plurality of servers.

Financial transaction computing network 100 further includes a communication network 130. Communication network 130 may include any type of network which allows for communication between central servers 110 and agent devices 120. For example, communication network 130 may comprise the Internet, WiFi, mobile communications networks such as GSM, CDMA, 3G/4G, WiMax, LTE, and the like. Further, communications network 106 may comprise a combination of network types working collectively.

Agent devices 120 correspond to one or more computing devices which are disposed at an agent location of a money transfer service. Such computing devices are configured with sufficient processing resources, memory, communications capabilities, and the like, to implement the functionality described herein. It is noted that in some embodiments an agent may have multiple devices at a particular location. Further, while only a small number of agent devices 120 are shown for the sake of simplicity, it is contemplated that financial transaction computing network 100 may include a very large number of agent devices 120 which are located worldwide. In some instances, multiple agent devices 120 may correspond to a particular chain of locations owned by an agent, while in other instances, an agent may have only a single location.

In some instances, particular groupings of agent devices 120 may be administered to by a pre-determined central server 110. Such a relationship may be established based on physical proximity of the devices and/or based on capabilities of the devices, e.g. processing resources, bandwidth availability, and the like. In other instances agent devices 120 may be administered to by a central server 110 based on other considerations, such as communication availability, processing resources, etc.

Agent devices 120 may include one or more peripheral devices 121a-n. Peripheral devices 121a-n may be any device that is used by a money transfer agent. For example, peripheral devices 121a-n may include a money order printer, an identification capture device (e.g. a signature pad, camera, pin pad module, card swipe module, biometric scanner, etc.), printing device, and the like. More particularly, peripheral devices 121a-n may be devices that the parent entity may want to exert some form of control over, or otherwise receive information from. Such aspects are discussed in more detail below.

In some embodiments an agent location may comprise multiple agent devices 120′. Such devices may be configured to communicate with each other (e.g. in a local network or over communication network 130) and share peripheral devices 121a′-121n′. In this manner, an agent device not having peripherals may share the peripherals of another agent device. Such a configuration may be found in many agent locations. For example, an agent location may contain multiple point of sale agent devices which utilize a single money order printer device. It is noted that the local control of peripheral devices 121a′-121n′ may be handled by the agent device connected to the peripheral devices, or by the non-connected agent device. In any event, agent devices 120′ may also comprise instructions or otherwise be controlled (at least in part), by central server 110.

FIG. 2 illustrates a functional block diagram illustrating devices in a money transfer network system 200 in accordance with an embodiment of the present application. System 200 includes central server(s) 210 and an agent device 220. Central server(s) 210 and agent device 220 may be implemented as described above with respect to FIG. 1 and may be connected over a communication network, such as network 130, however, the communication paths have been simplified in order to illustrate various aspects of embodiments of the invention.

In the illustrated embodiment, agent device 220 is configured to execute a web browser 221 and a shell application 222. Web browser 221 may be any form of browser such as Internet Explorer™, Google Chrome™, Firefox™, and the like. Agent device 220 may utilize web browser 221 to navigate to a website hosted by a parent entity and may be administered by central server(s) 210. From the web browser 221, agent device 220 may perform steps to implement a money transfer transaction and may also be assisted by shell application 222. For example, shell application 222 may provide information for central server(s) 210 which would not be otherwise available when merely interfacing with a web browser.

Additionally, shell application 222 may provide access to devices connected to agent device 220 in a manner which would not have been directly available to web browser 221. For example, a web browser (even when running various plug-ins) is prevented from having access to various portions of a computing system, e.g. a web browser may not be provided with hardware-specific information about a computing device and/or its peripherals. Moreover, a web browser is not generally given full access to services available to a computing device. For example, while a user can print from a web browser, such an action usually provides the user with access to a print dialog which is administered by an operating system (e.g. the browser has little or no control of how/when a print job is completed once the print dialog has been opened).

It is noted that there are many methods and features that may be realized within the architecture FIG. 2. A discussion of examples of such features is provided below. It is noted that many of the features may be utilized alone or in combination with other features. Such features may be implemented by various modules 223 that are part of shell application 222. Modules 223 may send and receive information via a container module routing process 224 and may be updated via module updating process 225. It is further noted that data or information from shell application 222 and its accompanying modules may be sent to server 210 directly from shell application 222 or provided via an interface provided by web browser 221.

In many cases, when an agent is initiating or completing a financial transaction via web browser 221 on agent device 220, some form of login authentication may be utilized to insure that the agent is qualified to implement the transaction. In accordance with some embodiments, further hardware authentication information may be gathered in addition to or in lieu of other authentication data. For example, modules 223 of shell application 222 may include an authentication module configured to access hardware information, other profile information, information provided to a specific agent device for identification purposes, etc., about agent device 220 which would not normally be accessible to a web browser program. In this manner, shell application 222 may cause such information to be provided to server 210 to provide for additional authentication of a transaction as it may identify an agent device in order to make a determination as to whether that agent device belongs to a particular agent and is authorized to implement financial transactions.

In one embodiment agent device 220 may initiate a transaction offline, e.g. with the help of an application resident on the agent device. Such an application may be configured such that at some point in the transaction (e.g. when transaction information is received, near completion of the transaction, or during any other time) the application may utilize shell application 222 to complete the transaction. The use of shell application 222 may occur in any number of ways, for example, the shell application may launch a browser on agent device 220 (with or without the assistance of shell application 222) and to utilize a web-based interface with a central server to complete the transaction. In such embodiments, information provided to the offline transaction may be uploaded to the web-based interface by one or more of the offline application and shell application 222. In another example, the offline application may directly utilize shell application 222 (which functions under control of server 210) to complete the transaction, e.g., by using peripherals controlled by shell application 222.

In one embodiment an authentication module may execute on agent device 220 and create a device fingerprint for agent device 220. This fingerprint may then be provided to server 210, whereupon, when a transaction is being initiated by an agent machine, central server 210 may receive fingerprint data via web browser 221 or may interrogate agent device 220 and retrieve fingerprint data from shell application 222 and compare the received fingerprint data with the originally created device fingerprint.

In some embodiments, shell application 222 may also include one or more interactive device modules as part of modules 223. For example, interactive device module may control access to a pin pad, card swipe and/or a signature pad which may be connected as one or more external peripheral devices (such as peripheral devices 121). Allowing for such control by shell application 222 may provide for multiple advantages. For example, a pin pad may be utilized in some embodiments to obtain additional authentication for a user of system 200 (e.g. an agent and/or customer initiating a financial transaction). A card swipe machine may also be utilized to identify a customer, provide for payments in a transaction, etc. Further, a signature pad may be utilized to obtain signatures which may be required to complete a transaction.

It is noted that the ability to control such devices by a parent entity through shell application 222 may be utilized in various ways. For example, a parent entity may want to require a physical swipe of a card and/or a pin number to be entered, and controlling such devices may prevent an agent entity from bypassing such requirements. Further, regulatory requirements of a particular jurisdiction may require that signatures are obtained in order to facilitate the initiation or completion of a financial transaction. With control of a signature pad device, the parent entity may ensure that appropriate signatures are captured during a financial transaction.

Further, an interactive device module may obtain device fingerprint information corresponding to one or more connected hardware devices, such as a signature pad, pin pad, card swipe pad, and the like. Additionally, a token may be utilized, such as a revolving password, to authenticate the agent device. This fingerprint and/or token information may be provided to an authentication module and utilized to provide for additional security for a transaction.

In another embodiment, shell application 222 may include a money order printer module as part of modules 223 to control a money order printer at an agent location. It is noted that control of a money order printer may be maintained by a parent entity as a measure to prevent or minimize fraudulent transactions. For example, in one embodiment, an agent may establish a money order transaction via a web application on web browser 221 of agent device 220, or on a program residing on the agent device 220. In order to print the money order, a module on shell application 222 provides access to the money order printer in accordance with instructions received by central server 210. Such instructions may be received at a previous point in time or on a real-time basis.

In yet another embodiment, modules 223 may include a module that controls a printing device which is connected to agent device 220. In some instances, such a printer may be totally controlled by shell application 222. However, in other embodiments, a printing device may be only partially controlled by shell application 222 when the printer is being utilized as part of a financial transaction. For example, an agent device may utilize a printer to print during the normal course of its functionality and it may be controlled in a normal manner. Concurrently, upon a financial transaction being implemented, control of the printing device may be implemented through shell application 222. Such control may be useful when, for example, procedures of a parent entity may require that multiple printed copies of financial transaction documents be produced, to provide for an alternative print layout, or to provide for any other setup which would not necessarily be required when utilizing a standard print dialog tool.

It is noted that the modules 223 are not limited to the above examples. Embodiments may utilize any number of modules and control any number of peripheral devices in accordance with the concepts outlined herein. For example, an agent location may utilize other devices, such as hand-held devices (e.g. tablets, smartphone-style devices, etc.) in the course of conducting financial transactions. It may be advantageous at times for a parent entity to limit or provide for specific functionality of such devices in accordance with various considerations. Such variations are considered within the scope of the present embodiments.

It is also noted that control over local agent devices by a central or parent entity may be implemented to assist with compliance with any number of regulations or internal policies. For example, certain jurisdictions may require signatures, multiple receipt copies, etc., for financial transactions. Additionally, internal procedures may require various forms of identifying a customer, e.g. signatures, card/identification swipes, etc., for best-practice purposes within the parent entity. Maintaining control over a local device in any such circumstances, e.g. as described herein, is considered within the scope of the present application. In some embodiments, the control provided through shell application 222 may also allow a central entity to halt one or more operations at an agent entity, e.g. in the event that the agent entity is not following procedures correctly, and the like.

Shell application 222 also includes container module routing process 224. Container module routing process is configured to control communications between one or more of the web browser/web application and the central server. For example, data may be conveyed to an agent device as part of normal web-browser session whereupon at least a portion of such data may be provided to shell application 222. Data transmitted from shell application 222 may also be provided to a central server 210. This data may be provided directly through agent device 220 via the shell application 222. Alternatively, this data may be provided via the web browser.

Shell application 222 may also include an updating process module 225. In one embodiment, updating process module 225 may update existing modules and add extra modules, if desired. For example, in the event that the parent entity desires to provide specifically approved programs or modules, such modules may be installed using updating process module 225. Further, updating process module 225 may update fingerprint data upon changes being made to computer (e.g. hardware/peripheral changes, updates in required data to be given/sent in a financial transaction, and the like). Updating process module 225 may also update the shell application in the event that software changes have altered the performance on the computer (e.g. updated browsers).

Shell application 222 may also include a module which provides font information, language packs, code pages, and the like. Such a module may be useful, for example, when the client device may not be configured with a specific language pack and may need to print, conduct portions of a transaction, or otherwise provide transaction information in a different language. In this manner, shell application 222 may be configured with these resources and either provide it to the client device, or make such resources available to the client device via the shell application. It is noted that internal regulations of a money transfer service and/or governmental regulations may require certain languages or fonts to be utilized at various points in a money transfer transaction (e.g. printing transaction terms or receipts in various languages). Modules of shell application 222 may be configured in a manner to provide the resources needed to comply with such regulations.

It is further noted that client device 220 may be configured with a storage medium. Such a medium may be configured to store information, such as transaction information, to the client device. This storage may be implemented under at least partial control of shell application 222, through the web-based application, or under the total control of the client device. It is also noted that internal regulations and/or governmental regulations may require one or more details to be stored by a device facilitating a financial transaction. The storage medium may be configured in a manner to comply with such regulations.

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 3 illustrates a method 300 for performing a financial transaction in accordance with an embodiment of the present application. It is noted that method 300 may be implemented within one or more systems, such as systems 100 and 200 described above. Method 300 includes providing a web-based interface which allows an agent to provide details regarding a financial transaction from an agent computing device, at block 310. Such an interface may include a web-based program which allows a user to input information corresponding to a financial transaction in order to establish the transaction in a financial services network through a parent entity.

Method 300 may also include providing a shell application to the agent computing device wherein the shell application is configured to access resources of the agent computing device, at block 320. Such access may include obtaining authentication information as discussed above. Further, in some embodiments, access to resources of the agent computing device may include accessing and at least partially controlling one or more peripheral devices.

Method 300 may also, at block 330, utilize the web-based interface and resources accessed by the shell application to generate the financial transaction. This step may be implemented as discussed above. For example, resources of the agent computing device may be utilized to authenticate a transaction being initiated via the web-based interface. Moreover, control over peripheral devices may be utilized to insure that various procedures and/or regulations are being adhered to, e.g., the correct number of copies of a transaction receipt are being copied, the correct signatures are being obtained, proper identification of a transacting party is obtained, etc.

It is noted that in some embodiments method 300 may include further steps to facilitate the functionality of the shell application and to provide for efficient transaction creation. For example, method 300 may include updating the shell application from time-to-time in order to ensure that the appropriate software is functioning on an agent device in order to utilize one or more of the web application, peripheral devices, and the like. Method 300 may further include various authentication steps to authenticate a transaction and/or to authenticate a device which is formulating a transaction. For example, method 300 may compile profile data corresponding to a user and/or hardware device in order to make and maintain a device fingerprint and/or token which may be utilized to ensure that an agent device can appropriately create a requested transaction.

FIG. 4 illustrates a method 400 for performing a financial transaction in accordance with an embodiment of the present application. It is noted that method 400 may be implemented within one or more systems, such as systems 100 and 200 described above. Method 400 may include receiving transaction data at a central server which is entered at an agent device via a web interface at block 410. Such data may be received from an agent device via a web-based interface or program. Method 400 may also include authenticating the agent device by receiving data provided via a shell application residing on the agent device at block 420. Such authentication of the device may be implemented using the fingerprinting/token methods discussed above. Further, it is noted that the received data may comprise another device specific identification means which may include any means that may accurately identify the particular agent device in a manner that authentication may be achieved.

Method 400 may also, upon authenticating the agent device, provide access, by the central server, to one or more resources on the agent device via the shell application at block 430. Such access may include providing for communication and selective control of devices as discussed above with respect to FIG. 2, e.g., providing for control to print documents in a particular manner, obtaining signatures or pins from a user, and the like.

It is noted that the functional blocks and modules in FIGS. 1-2 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
providing a web-based interface which allows an agent to provide details regarding a financial transaction from an agent computing device;
providing, by a processing device, a shell application to the agent computing device wherein the shell application is configured to access resources of the agent computing device wherein the shell application is remotely reconfigurable by a parent entity; and
utilizing the web-based interface and resources accessed by the shell application to facilitate the financial transaction.

2. The method of claim 1 wherein the shell application is configured to compile an authentication fingerprint of the agent computing device to a central server.

3. The method of claim 1 wherein the shell application is configured to provide a central server with authentication information corresponding to the agent computing device upon a financial transaction being initiated.

4. The method of claim 1 wherein the shell application is configured to control access to one or more peripheral devices on the agent computing device.

5. The method of claim 4 wherein the peripheral devices are selected from a group comprising a printer, a money order printer, a pin pad and a signature pad.

6. The method of claim 4 wherein the one or more peripheral devices are directly connected to the agent computing device.

7. The method of claim 4 wherein the one or more peripheral devices are connected to the agent computing device via local network.

8. The method of claim 1 further comprising updating the shell application via a central server.

9. A computer program product having a non-transitory computer readable medium with code encoded thereon which, when executed causes one or more processing devices to:
administer a web-based interface which allows an agent to provide details regarding a financial transaction from an agent computing device;
administer a shell application to the agent computing device wherein the shell application is configured to access resources of the agent computing device; and
utilize the web-based interface and resources accessed by the shell application to facilitate the financial transaction.

10. The computer program product of claim 9 wherein the shell application is configured to compile an authentication fingerprint of the agent computing device to a central server.

11. The computer program product of claim 9 wherein the shell application is configured to provide a central server with authentication information corresponding to the agent computing device upon a financial transaction being initiated.

12. The computer program product of claim 9 wherein the shell application is configured to control access to one or more peripheral devices on the agent computing device.

13. The computer program product of claim 12 wherein the peripheral devices are selected from a group comprising a printer, a money order printer, a pin pad and a signature pad.

14. The computer program product of claim 12 wherein the one or more peripheral devices are directly connected to the agent computing device.

15. The computer program product of claim 12 wherein the one or more peripheral devices are connected to the agent computing device via local network.

16. The computer program product of claim 9 further comprising code which, when executed is configured to update the shell application via a central server.

17. A method comprising:
receiving transaction data at a central server, said transaction data entered at an agent device via a web interface;
authenticating the agent device by receiving data provided via a shell application residing on the agent device;
upon authenticating the agent device, providing access, by said central server, to one or more resources on the agent device via the shell application.

18. The method of claim 17 wherein providing access to one or more resources on the agent device includes providing access to a money order printer connected to the agent device.

19. The method of claim 17 wherein said providing access to one or more resources includes controlling a peripheral device connected to the agent device in order to require compliance with one or more requirements pertinent to the transaction.

20. The method of claim 19 wherein requiring compliance includes causing the peripheral device to print multiple copies of a transaction receipt.

21. The method of claim 19 wherein requiring compliance includes causing the peripheral device to obtain a signature of a transacting party.

22. The method of claim 19 wherein requiring compliance includes causing the peripheral device to obtain a pin number of a transacting party.

23. The method of claim 19 wherein said requirement is a procedural requirement of a parent entity.

24. The method of claim 19 wherein said requirement is a regulatory requirement of a governmental entity.

25. The method of claim 17 wherein authenticating the agent device includes comparing received authentication data to an agent device fingerprint.

26. An apparatus configured for implementing financial transactions, the apparatus comprising:
an agent computer having at least one processor and memory coupled to the at least one processor, wherein the at least one processor is configured to:
execute a web-based transaction application which allows a user to input transaction details in order to initiate a financial transaction; and
execute a shell application which provides a pre-determined level of access to resources of the agent computer, said level access provided by the shell application controlled by a central server.

27. The apparatus of claim 26 wherein said pre-determined level of access grants permission to utilize a peripheral device which is in communication with the agent computer.

28. The apparatus of claim 26 wherein said pre-determined level of access grants access to utilize a peripheral device in a specific manner.

29. The apparatus of claim 28 wherein the specific manner includes requiring the peripheral device to function in order to meet a governmental regulatory requirement for implementing financial transactions.

30. The apparatus of claim 28 wherein the specific manner includes requiring the peripheral device to function in order to meet an internal procedural requirement of a parent entity which controls the central server for implementing financial transactions.

31. The apparatus of claim 28 wherein the specific manner requires that a peripheral device is configured to require one or more of multiple printed copies of a transaction receipt to be printed and to obtain a signature from a transacting party.
